(19) United States
(12) Patent Application Publication
(10) Pub. No.: US 2022/0085430 A1
(43) Pub. Date: Mar. 17, 2022

(54) Battery Module

(71) Applicant: ads-tec Energy GmbH, Nurtingen (DE)

(72) Inventor: Thomas Speidel, Markgröningen (DE)

(21) Appl. No.: 17/465,879

(22) Filed: Sep. 3, 2021

(30) Foreign Application Priority Data
Sep. 11, 2020 (EP) 20 195 812.1

(51) Int. Cl. H01M 10/48; H02J 7/00; H01M 50/502

(52) U.S. Cl. CPC H01M 10/482; H02J 7/0047; H01M 50/107; H02J 7/0045; H02J 7/0024; H01M 50/502

(57) ABSTRACT

A battery module has a total of 144 battery cells, wherein the battery cells each have an individual voltage value and wherein the battery module has an output voltage value. The battery cells are connected to each other to form one or more groups of battery cells, wherein, when more than one group of battery cells are formed, the groups of battery cells each contain the same number of battery cells, and wherein the battery cells in each one of the one or more groups of battery cells are connected in parallel to each other. When more than one group of battery cells are formed, the groups of battery cells are connected in series. The battery module provides different connection schemes of the battery cells to form the one or more groups of battery cells connected in series.

### BACKGROUND OF THE INVENTION

The invention relates to a battery module comprising a plurality of battery cells, wherein each battery cell comprises an individual voltage value, wherein the battery module comprises an output voltage value, wherein a connection of the battery cells is done such that each battery cell is assigned to a group, wherein each group contains the same number of battery cells, wherein the battery cells belonging to a group are connected in parallel, wherein the groups are connected in series, wherein various connection schemes with groups connected in series are possible.

The invention further relates to a method for producing a battery module, wherein the battery module comprises a plurality of battery cells, wherein each battery cell comprises an individual voltage value, wherein the battery module comprises an output voltage value, wherein the battery cells are electrically connected to each other such that each battery cell is assigned to a group, wherein each group contains the same number of battery cells, wherein the battery cells belonging to a group are connected in parallel, and wherein the groups are connected in series.

DE 10 2016 207 572 A1 discloses a battery module with a plurality of battery cells whose cell contacts are variably connectable to each other by cell connectors for generating a module voltage.

Often, a defined output or module voltage is required. In order to provide a module voltage that is lower than the maximum module voltage, in DE 10 2016 207 572 A1 the voltage is not tapped at all battery cells that are connected in series. At times, many battery cells are not in use at all in this context.

### SUMMARY OF THE INVENTION

It is the object of the invention to further develop a battery module of the aforementioned kind such that different module voltages can be made available by utilizing all battery cells of the battery module.

In accordance with the invention, this is achieved by a battery module comprising a plurality of battery cells, wherein each battery cell comprises an individual voltage value, wherein the battery module comprises an output voltage value, wherein a connection of the battery cells is done such that each battery cell is assigned to a group, wherein each group contains the same number of battery cells, wherein the battery cells belonging to a group are connected in parallel, wherein the groups are connected in series, wherein various connection schemes forming groups connected in series are possible, wherein the battery module comprises in total precisely 144 battery cells that are connected to each other.

A further object of the invention resides in providing a method for producing a battery module with which different module voltages can be achieved by utilizing all battery cells of the battery module.

This object is solved by a method for producing a battery module, wherein the battery module comprises a plurality of battery cells, wherein each battery cell comprises an individual voltage value, wherein the battery module comprises an output voltage value, wherein the battery cells are electrically connected to each other such that each battery cell is assigned to a group, wherein each group contains the same number of battery cells, wherein the battery cells of a group are connected in parallel, and wherein the groups are connected in series, wherein the battery module comprises in total precisely 144 battery cells connectable to each other.

In respect to the battery module, the invention provides that the battery module comprises in total precisely 144 battery cells that are connected to each other. A connection of the battery cells is configured such that each battery cell is assigned to a group. Each group of battery cells contains the same number of battery cells. Each group of battery cells contains a battery number of battery cells. In this way, a simple configuration of the connection scheme is provided. The battery cells belonging to a group of battery cells are connected in parallel. The groups are connected in series. The battery module comprises a group number of groups of battery cells. For constructively identical battery cells that each have comparable voltage values, the groups that are connected in series will discharge in comparable time periods because each group contains the same number of battery cells. Various connection schemes are possible for providing groups that are connected in series.

Since precisely 144 battery cells are provided in total, the battery cells can be connected such that very many different output voltages of the battery module can be achieved. The invention is based on the recognition that the number 144 has a particularly large number of divisors. For a total number of battery cells of 144 in the battery module, despite the boundary conditions that each group must contain the same number of battery cells, very many combinations of battery numbers and group numbers are possible. In this context, every individual battery cell of the battery module is utilized.

Advantageously, the battery module provides different output voltage values as a function of the connection schemes. In this way, the battery module can be produced with the same spatial configuration in regard to the arrangement of the battery cells and still can provide different output voltages by a different connection scheme of the battery cells to each other. Many electrically different battery modules can be produced based on the same configuration in respect to the spatial arrangement of the battery cells. This saves production costs and increases the flexibility.

Advantageously, a total of precisely 15 different connection schemes of the 144 battery cells to groups that are connected in series are possible. Advantageously, precisely 15 different output voltages can be produced due to the different connection schemes. In this way, 15 different output voltages can be achieved while the arrangement of the battery cells in regard to the spatial configuration of the battery module remains the same.

Expediently, all battery cells of the battery module that are connected to each other are identical in configuration. An average voltage value of all battery cells results based on the individual voltage values of all battery cells that are connected to each other. In particular, the individual voltage values of all battery cells of the battery module that are connected to each other deviate by less than 10%, in particular by less than 5%, from the average voltage value of all battery cells.

Advantageously, the connection of the battery cells can be done such that the output voltage value amounts to one to 144 times the average voltage value of all battery cells. In this way, a large range of output voltage values can be produced with the battery module.

Expediently, the output voltage value corresponds to the product of the average voltage of all battery cells multiplied by 1, 2, 3, 4, 6, 8, 9, 12, 16, 18, 24, 36, 48, 72 or 144.

Advantageously, the battery number of battery cells of a group amounts to 1, 2, 3, 4, 6, 8, 9, 12, 16, 18, 24, 36, 48, 72 or 144. In particular, a group comprises precisely one battery number of battery cells. Expediently, the group number of groups amounts to 1, 2, 3, 4, 6, 8, 9, 12, 16, 18, 24, 36, 48, 72 or 144. In particular, the battery cells that are connected to each other are divided into precisely one group number.

Expediently, the product of battery number multiplied by group number amounts to 144.

Advantageously, the battery module comprises a battery cell support. In particular, the battery cells are arranged spatially unchanged in the battery cell support, independent of the different connection schemes. Even for a different selection of the connection scheme, the spatial arrangement of the battery cells in the battery cell support remains the same.

In an advantageous further embodiment of the invention, the battery module comprises contact paths. In particular, the connection of the battery cells is realized by means of contact paths. The contact paths can be arranged on a contact support. It is also possible to provide two contact supports. The positive pole of a battery cell is then facing the first contact support and the negative pole of the same battery cell is then facing the second contact support.

Expediently, all battery cells of the battery module are connected to each other. In this way, no resources are wasted and the entire power potential of the battery module can be tapped.

In an advantageous further embodiment of the invention, it is provided that the positive poles of 72 battery cells face in one pole direction and that the positive poles of the other 72 battery cells are facing in the opposite pole direction. In this way, the different groups of battery cells can be connected in a simple manner in series. For this purpose, a positive pole of a battery cell which is facing in pole direction can be connected with a negative pole of another battery cell that is also facing in pole direction. In this way, a contact path must not be guided in the pole direction or opposite to the pole direction along a battery cell.

Expediently, the battery cells are round cells.

Advantageously, the individual voltage values of all battery cells of the battery module that are connected to each other amounts to 2 V to 5 V, respectively, in particular 3 V to 4 V. For battery cells with such individual voltage values and a battery module with 144 battery cells, a battery module with a beneficial size is provided. For battery cells with such individual voltage values and a battery module with 144 battery cells, a battery module with a beneficial energy content is provided. In particular, the output voltage value amounts to 2 V to 720 V, preferably 3 V to 576 V.

According to the method of the present invention for producing a battery module with a plurality of battery cells, wherein each battery cell comprises an individual voltage value and wherein the battery module comprises an output voltage value, it is provided that the battery cells are connected electrically to each other such that each battery cell is assigned to a group. Each group contains the same number of battery cells. The battery cells of a group are connected in parallel. The groups are connected in series. The battery module in total comprises precisely 144 battery cells that are connected to each other. In this way, the battery module can be produced always in the same manner in regard to spatial arrangement of the battery cells. In spite of this, by means of different connection schemes of the individual battery cells very many different output voltage values can be achieved. In this way, costs can be saved for producing the battery module. Battery modules with very many different output voltages can be produced on the basis of the same configuration of the battery module with respect to the spatial arrangement of the battery cells.

In particular, different output voltage values of the battery module can be generated by different connection schemes of the battery cells with each other with a spatially unchanged arrangement of the battery cells.

Advantageously, the battery cells can be electrically connected in such a way with each other that a total of precisely 15 different output voltage values can be generated.

### BRIEF DESCRIPTION OF THE DRAWING

Embodiments of the invention will be explained in the following with the aid of the drawings.

FIG. 1a shows a perspective illustration of a battery cell support of a battery module with battery cells.

FIG. 1b is a schematic side view of a battery module with the battery cell support of FIG. 1a.

FIG. 2 is a schematic illustration of the spatial arrangement of 144 battery cells of a battery module in twelve rows and twelve columns.

FIG. 3 is a schematic illustration of a contact support of a battery module with contact paths.

FIG. 4 is a schematic illustration of the battery cells of FIG. 2 and of the contact support of FIG. 3 upon contact of the contact paths of the contact support at the battery cells.

FIG. 5 is a schematic illustration of a second contact support and of the bottom side of the battery cells of FIG. 2 for contact of the second contact paths of the second contact support to the bottom side of the battery cells.

FIG. 6 is a schematic circuit diagram of a connection scheme of the battery cells of the battery module according to FIG. 2 with twelve groups connected in series and with twelve battery cells belonging to a group, respectively, and connected in parallel.

FIG. 7 is a schematic circuit diagram of a connection scheme of the battery cells of the battery module according to FIG. 2 with 24 groups connected in series and with six battery cells belonging to a group, respectively, and connected in parallel.

FIG. 8 is a schematic circuit diagram of a connection scheme of the battery cells of the battery module according to FIG. 2 with 144 groups connected in series and with one battery cell belonging to a group, respectively.

### DESCRIPTION OF PREFERRED EMBODIMENTS

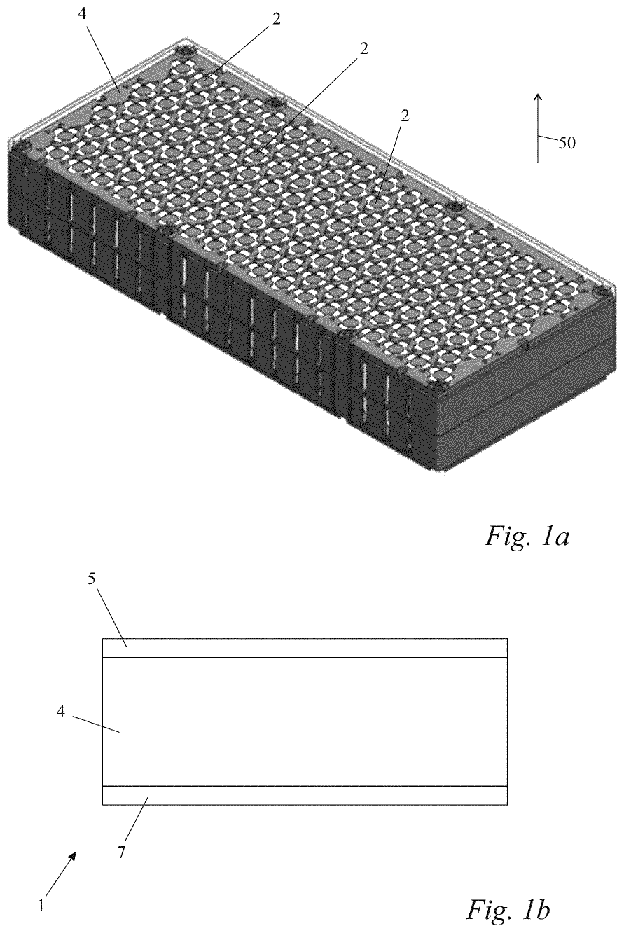

FIG. 1a shows a battery cell support 4 of a battery module 1. The battery cell support 4 carries battery cells 2. In the battery cell support 4, precisely 144 battery cells 2 are arranged. The battery cells 2 are arranged adjacent to each other. In the embodiments, the electrical poles of all battery cells 2 are arranged in precisely two planes. It can also be provided that the electrical poles of all battery cells 2 are lying precisely in one plane.

FIG. 1b shows a schematic side view of a battery module 1. The battery module 1 comprises the battery support 4 of FIG. 1a, a first contact support 5, and a second contact support 7. The battery support 4 is arranged between the first contact support 5 and the second contact support 7.

The battery cell support 4 and the battery cells 2 form the basic shape of the battery module 1 with different output voltage values. The different output voltage values of the battery module 1 are achieved by differently connecting the individual battery cells 2 with each other. The spatial arrangement of the battery cells 2 in the battery cell support 4 remains unchanged in this context. All battery cells 2 of the battery module 1 that are connected to each other are of identical configuration. The individual voltages of all battery cells 2 of the battery module 1 that are connected to each other deviate respectively by less than 10%, in particular by less than 5%, preferably by less than 2%, from an average voltage value of all battery cells 2. The average voltage value of the battery cells 2 is the average value of the individual voltage values of 144 battery cells 2. The individual voltage values of all battery cells 2 of the battery module 1 that are connected to each other amount to 2 V to 5 V, in particular 3 V to 4 V, respectively.

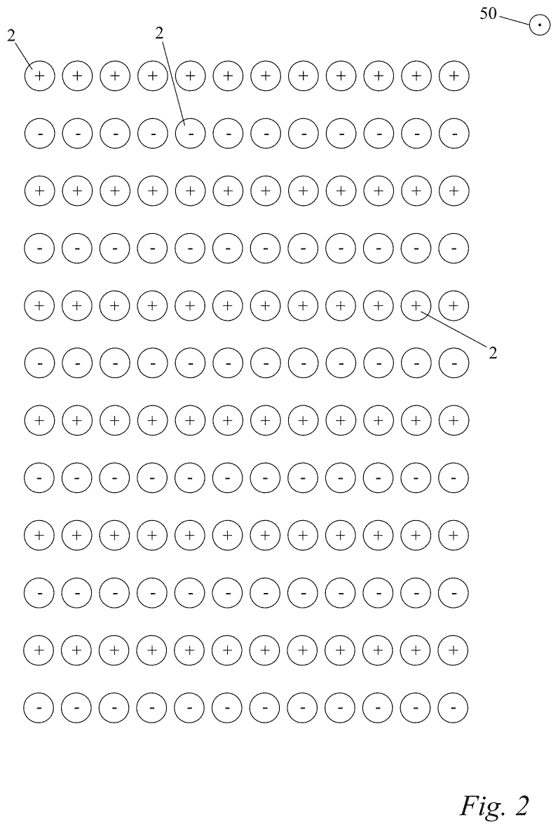

FIG. 2 shows a schematic illustration of an arrangement of battery cells 2 in a battery cell support, not illustrated. The battery cells 2 are arranged in twelve rows and in twelve columns. However, any other arbitrary arrangement of the battery cells can be provided. Preferably, the battery cells 2 are arranged in 36 rows of four battery cells 2 each that are displaced relative to each other, as illustrated in FIG. 1a. The battery cells 2 are arranged in FIG. 1a in four columns and 36 rows. Neighboring battery cells 2 in a column are slightly displaced relative to each other. The width of a column is somewhat larger than the width of a battery cell 2. FIG. 2 serves for simplified illustration of the principle of the invention. The basic principle is in this context that the spatial arrangement of the battery cells 2 remains unchanged independent of their respective connection scheme.

FIG. 2 shows a plan view from above of the battery cells 2 or of the battery module 1 or the battery support 4. In the embodiments, the battery cells 2 are round cells.

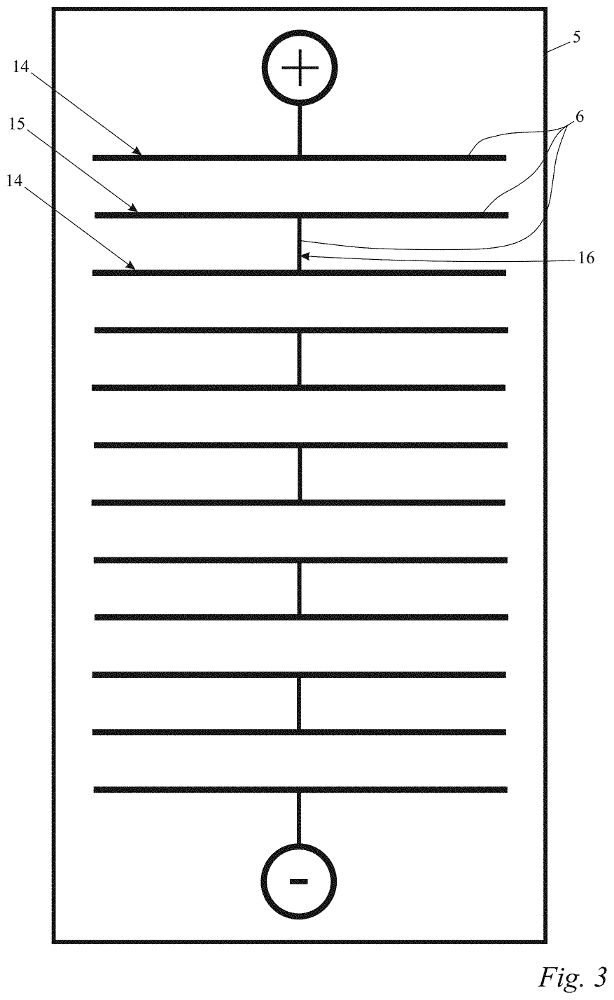

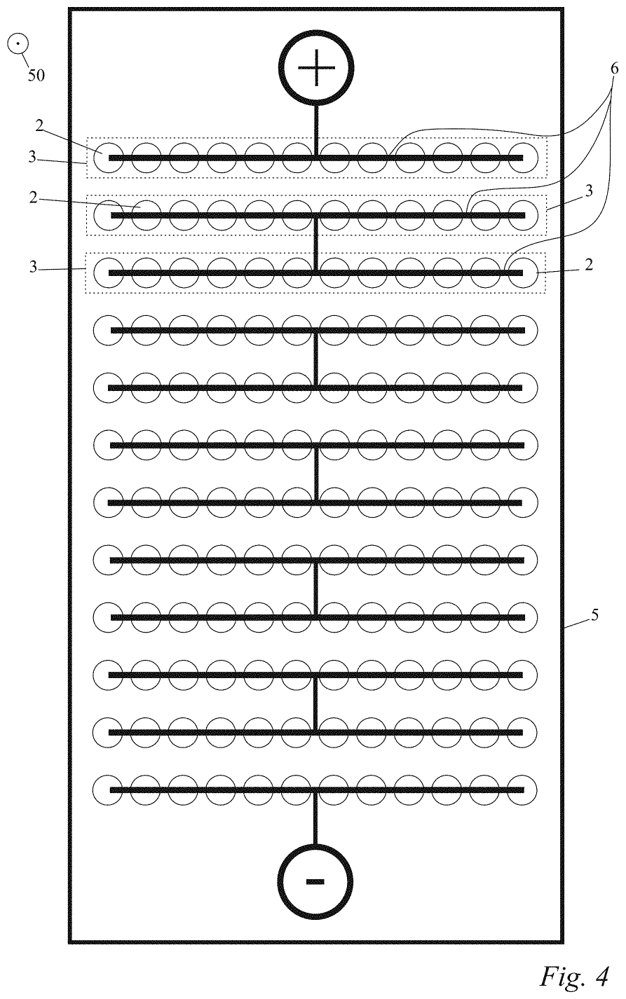

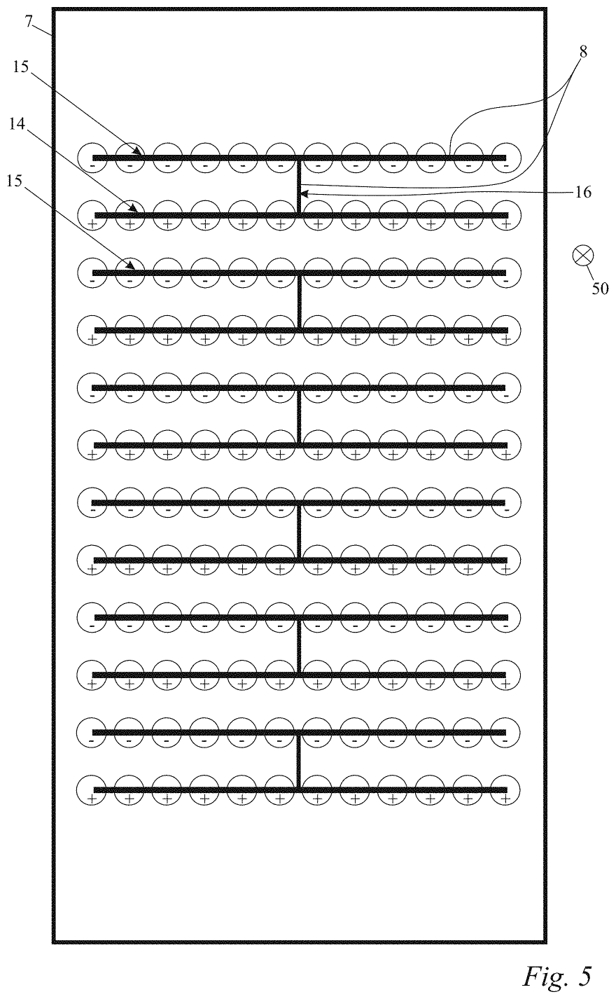

The connection of the battery cells 2 with each other is realized in the embodiment by first contact paths 6 illustrated in FIG. 3 and by second contact paths 8 illustrated in FIG. 5. The contact paths 6 are arranged on a first contact support 5. The second contact paths 8 are arranged on a second contact support 7. However, it can also be provided that the contact paths 6 and 8 are fastened only to the battery cells 2. An arrangement of a contact support is not mandatory. In the embodiments, the battery cells 2 are arranged between the first contact support 5 and the second contact support 7. FIG. 4 shows schematically the arrangement of the contact support 5 on a top side of the battery cells 2. FIG. 5 shows schematically the arrangement of the second contact support 7 on a bottom side of the battery cells 2. To simplify the drawing, the electrical poles in FIG. 5 are illustrated off-center in relation to the battery cells 2 embodied as round cells. The positive poles are identified by “+” and the negative poles by “−”. In FIG. 2, the battery cells 2 are illustrated in a view of the top side of the battery module 1. In FIG. 5, the battery cells 2 are illustrated in a view of the bottom side of the battery module 1. The battery cells 2 which are illustrated in the first uppermost row in FIG. 2 are the same as those illustrated also in the first uppermost row in FIG. 5. The battery cell 2 that is illustrated in FIG. 2 all the way to the left at the top is illustrated in FIG. 5 at the top all the way to the right. FIG. 2 shows the view of the positive pole of this battery cell 2; FIG. 5 shows the view of the negative pole of this battery cell 2.

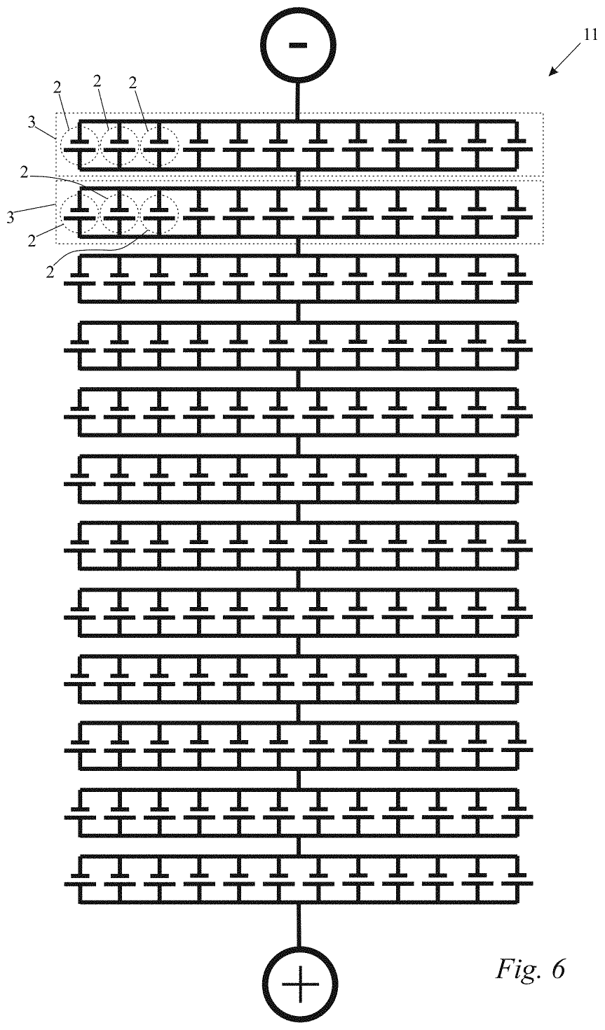

Due to the first contact paths 6 and the second contact paths 8, a connection scheme 11 of the battery cells 2 is realized which is illustrated schematically in FIG. 6.

The connections of the battery cells 2 are configured such that each battery cell 2 is assigned to a group 3 (FIG. 4). Each group 3 contains the same number of battery cells 2. The battery cells 2 of a group 3 are connected in parallel. The groups 3 of battery cells 2 are connected in series. A group 3 is also referred to as a bundle of battery cells 2. The same type electrical poles of the battery cells 2 of the same group 3 are electrically at the same potential. The individual currents of the battery cells 2 of the same group 3 form a group current. The group current corresponds to the sum of the individual currents of the battery cells 2 of the same group 3. The group currents of all groups 3 are of the same magnitude. The group current of each group 3 corresponds to the module current of the entire battery module 1.

The connection scheme via the first contact paths 6 and the second contact paths 8 according to FIGS. 3 to 5 is designed such that twelve battery cells 2 are arranged in a group 3. The battery cells 2 are divided into a total of twelve groups 3. The twelve battery cells 2 of a group 3 are connected in parallel. The positive poles of the battery cells 2 of the same group 3 are at the same electrical potential due to the connection. The negative poles of the battery cells 2 of the same group 3 are at the same electrical potential due to the connection. The twelve groups 3 are connected in series.

The battery module 1 comprises a total of precisely 144 battery cells 2 that are connected to each other. In the embodiments, all battery cells 2 of the battery module 1 are connected to each other. There are no battery cells provided that are not contributing to the output power of the battery module 1.

In FIG. 2, a pole direction 50 is illustrated. The pole direction 50 extends from the bottom side of the battery cells 2 in the direction to the top side of the battery cells 2. The pole direction 50 extends from the bottom side of the battery module 1 in the direction to the top side of the battery module 1. In FIG. 2, the electrical positive poles of the battery cells 2 are identified by “+”. The electrical negative poles of the battery cells 2 are identified by “−”. In the embodiment according to FIG. 2, the positive poles of the battery cells 2 of the rows one, three, five, seven, nine, and eleven point in pole direction. The numbering of the rows in FIG. 2 is from the top to the bottom. The 144 battery cells are arranged in twelve rows and in twelve columns. The positive poles of the battery cells 2 of the rows two, four, six, eight, ten, and twelve point in the direction opposite to the pole direction 50. Accordingly, the negative poles of the battery cells 2 of the rows one, three, five, seven, nine, and eleven point opposite to the pole direction. The negative poles of the battery cells 2 of the rows two, four, six, eight, ten, and twelve point in pole direction. The positive poles of 72 battery cells 2 point in pole direction 50. The positive poles of the other 72 battery cells 2 point in the direction opposite to the pole direction 50. However, it can also be provided that the positive poles of all 144 battery cells 2 point in the same direction, for example, in the pole direction 50. In this configuration, the negative poles of all 144 battery cells then face opposite to the pole direction 50 or also in the pole direction 50.

As can be seen in FIGS. 4 and 5, the battery cells 2 of a group 3 are connected electrically in parallel. The positive poles of the battery cells 2 of a group 3 are electrically connected to each other. The negative pole of the battery cells 2 of a group 3 are electrically connected to each other. The individual groups 3 are connected electrically in series by the first contact paths 6 and the second contact paths 8. In the embodiment according to FIGS. 4 and 5, the negative poles of the battery cells 2 of the first row are connected with the positive poles of the battery cells 2 of the second row. The negative poles of the battery cells 2 of the second row are electrically connected to the positive poles of the battery cells 2 of the third row. This type of connection is continued in this manner. The positive poles of the battery cells 2 of the eleventh row are connected with the negative poles of the battery cells 2 of the twelfth row.

Due to the alternate arrangement of the electrical poles of the battery cells 2 of neighboring rows, the first contact paths 6 and the second contact paths 8 can extend in a plane, respectively. It is not necessary that electrical poles of the battery cells 2 are connected by electrical connections in the direction of the pole direction 50. The electrical connection of the electrical poles in pole direction 50 in the embodiments is realized by the battery cells 2 themselves. In another arrangement of the poles of the battery cells 2, it can however also be provided that the connection of the battery cells 2 is realized by connecting lines which extend in pole direction 50 along the battery cells 2.

The battery module 1 provides different output voltage values as a function of the connection schemes. In total, precisely 15 different connection schemes of the 144 battery cells 2 to groups 3 connected in series are possible. Due to the different connection schemes, a total of precisely 15 different output voltages can be generated. In the embodiments according to FIGS. 3 to 8, three of the total number of 15 different connection possibilities are illustrated.

In the connection scheme 11 according to FIGS. 3 to 6, twelve groups 3 each provided with twelve battery cells 2 are connected in series.

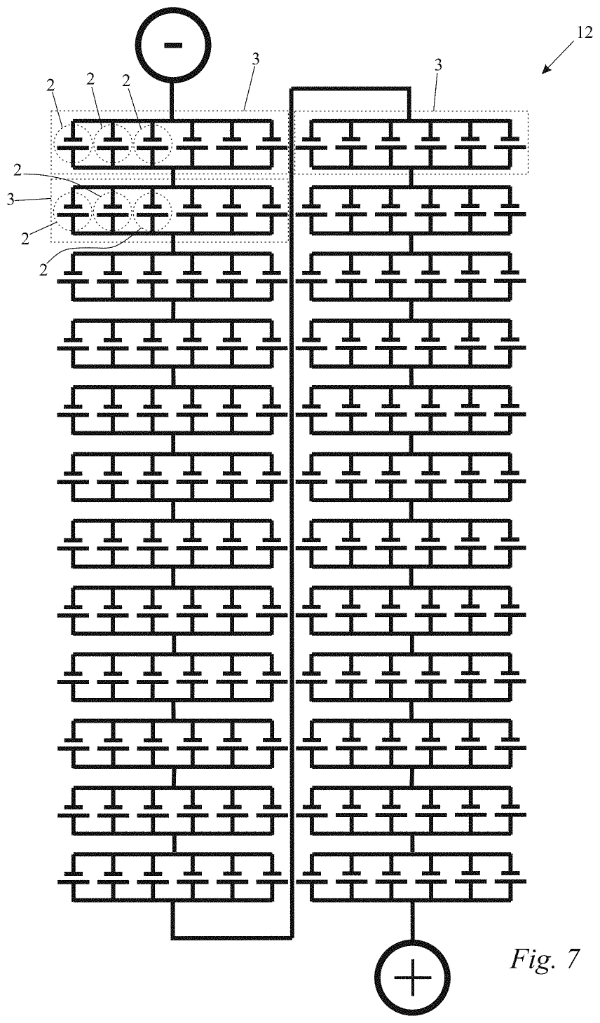

FIG. 7 shows a connection scheme 12 in which 24 groups 3 each provided with six battery cells 2 are connected in series. Each group 3 comprises six battery cells 2. By the connection scheme 12, an output voltage of the battery module 1 that is twice as high than the output voltage provided by the connection scheme 11 is achieved. The current of the battery module 1 with a connection scheme 11 is twice as high as the current of the battery module 1 with the connection scheme 12.

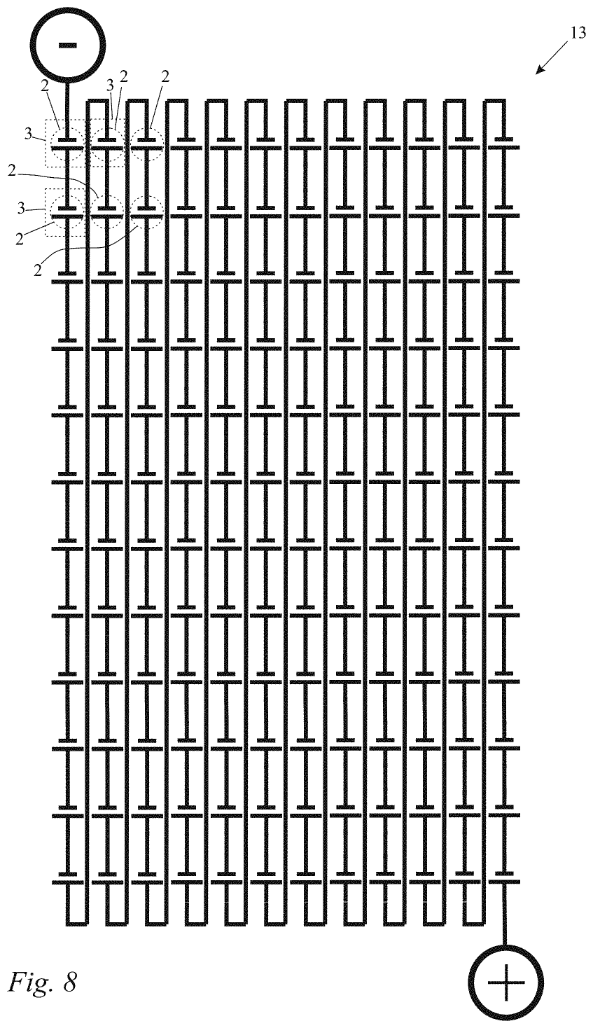

FIG. 8 shows a connection scheme 13 in which all battery cells 2 are connected in series. Each group 3 comprises thus only one battery cell 2. The connection scheme 13 divides the 144 battery cells 2 into 144 groups 3. By the connection scheme 13, the highest possible output voltage value of the battery module 1 is achieved. The current is minimal.

Independent of the different types of connection schemes 11, 12, 13, the battery cells 2 are arranged spatially unchanged in the battery cell support 4 (FIG. 1). In all 15 possibilities for the various connection schemes, the spatial arrangement of the battery cells 2 remains the same. The connection of the battery cells 2 can be embodied such that the output voltage value amounts to 1 to 144 times the average voltage value of all battery cells 2. In the embodiments, the output voltage value amounts to 2 V to 720 V, in particular 3 V to 576 V.

The output voltage value of the battery module 1 corresponds to the product of the average voltage value of all battery cells 2 multiplied by the number 1, 2, 3, 4, 6, 8, 9, 12, 16, 18, 24, 36, 48, 72 or 144. In the embodiment according to FIGS. 3 to 6, the output voltage value corresponds to the product of the average voltage value of all battery cells 2 multiplied by the number 12. In the embodiment according to FIG. 7, the output voltage value corresponds to the product of the average voltage value of all battery cells 2 multiplied by the number 24. In the embodiment according to FIG. 8, the output voltage value corresponds to the product of the average voltage value of all battery cells 2 multiplied by the number 144.

One group 3 comprises a battery number of battery cells 2. The battery number amounts to 1, 2, 3, 4, 6, 8, 9, 12, 16, 18, 24, 36, 48, 72 or 144. Each group 3 of a battery module 1 contains the same battery number of battery cells 2. In the embodiment according to FIGS. 3 to 6 the battery number is 12. In the embodiment according to FIG. 7, the battery number is six. In the embodiment according to FIG. 8, the battery number is one.

The battery cells 2 that are connected to each other are divided into precisely one group number of groups 3. The group number amounts to 1, 2, 3, 4, 6, 8, 9, 12, 16, 18, 24, 36, 48, 72 or 144. In the embodiment according to FIGS. 3 to 6, the group number is twelve. In the embodiment according to FIG. 7, the group number is 24. In the embodiment according to FIG. 8, the group number is 144.

The battery cells 2 of the battery module 1 can be connected such that the group number is 1 and the battery number is 144. The battery cells 2 of the battery module 1 can be connected such that the group number is 2 and the battery number is 72. The battery cells 2 of the battery module 1 can be connected such that the group number is 3 and the battery number is 48. The battery cells 2 of the battery module 1 can be connected such that the group number is 4 and the battery number is 36. The battery cells 2 of the battery module 1 can be connected such that the group number is 6 and the battery number is 24. The battery cells 2 of the battery module 1 can be connected such that the group number is 8 and the battery number is 18. The battery cells 2 of the battery module 1 can be connected such that the group number is 9 and the battery number is 16. The battery cells 2 of the battery module 1 can be connected such that the group number is 12 and the battery number is 12. The battery cells 2 of the battery module 1 can be connected such that the group number is 16 and the battery number is 9. The battery cells 2 of the battery module 1 can be connected such that the group number is 18 and the battery number is 8. The battery cells 2 of the battery module 1 can be connected such that the group number is 24 in the battery number is 6. The battery cells 2 of the battery module 1 can be connected such that the group number is 36 and the battery number is 4. The battery cells 2 of the battery module 1 can be connected such that the group number is 48 and the battery number is 3. The battery cells 2 of the battery module 1 can be connected such that the group number is 72 and the battery number is 2. The battery cells 2 of the battery module 1 can be connected such that the group numbers is 144 in the battery number is 1.

The group number is proportional to the output voltage value of the battery module 1.

The battery number of battery cells 2 in a group 3 is proportional to the group current of this group 3. The battery number is proportional to the module current of the battery module 1.

The product of battery number multiplied by group number results is 144. This applies to all 15 connecting possibilities.

In the method for producing the battery module 1, the battery cells 2 are electrically connected to each other such that each battery cell 2 is assigned to a group 3. Each group 3 of battery cells 2 contains the same number of battery cells 2. The battery cells 2 of a group 3 are connected electrically in parallel to each other. The groups 3 are connected electrically in series. In total, 144 battery cells 2 are connected to each other. In total, precisely 144 battery cells 2 are connected to each other. The battery module 1 comprises precisely 144 battery cells 2.

Different output voltage values of the battery module 1 can be generated by different connection schemes 11, 12, 13 (FIGS. 6 to 8) of the battery cells 2 to each other while the spatial arrangement of the battery cells 2 remains unchanged.

The connection is realized by the electrical connection of the positive poles of the battery cells 2 of the same group with a respective positive busbar 14 (FIG. 3, FIG. 5) by wires. In FIGS. 3 and 5, these wires are not illustrated. It can also be provided that the positive busbar 14 contacts immediately the positive poles of the battery cells 2. Wires for connecting the battery cells 2 with the positive busbars are then not required. The negative poles of the battery cells 2 of the same group 3 are connected with a respective negative busbar 15 by means of wires. The wires are not illustrated in FIG. 3. It can also be provided that the negative busbar 15 immediately contacts the negative poles of the battery cells 2. Wires for connecting the battery cells 2 with the negative busbar are then not required. The different groups 3 are connected by electrical connection of the negative busbars 15 and of the positive busbars 14 by wires 16 in series. In this context, only one negative busbar 15 is connected with only one positive busbar 14. The connections between battery cells 2, wires, negative busbars 15, and positive busbars 14 are soldered. The number of the positive busbars 14 and the number of the negative busbars 15 correspond respectively to the group number of groups 3. The negative busbars 15, the positive busbars 14, and all wires are illustrated in FIGS. 4 and 5 schematically as contact paths 6 and 8. The negative busbars 15 and the positive busbars 14 are part of the contact paths 6 or of the contact paths 8. The wires 16 are part of the contact path 6 or contact path 8. In the embodiments, the contact paths 6 are at least partially arranged on the contact support 5. The second contact paths 8 are at least partially arranged on the second contact support 7. However, it can also be provided that the contact paths are fastened exclusively to the battery cells 2. Contact supports are then obsolete. In the embodiments, on the contact support 5 negative busbars and positive busbars are arranged. In the embodiments, on the second contact support 7 negative busbars and positive busbars are arranged.

By producing the battery module 1 with the described method, based on a single battery support 4, battery modules 1 with 15 different output voltages can be produced. The manufacture of the battery support 4 is always the same. Its shape remains unchanged independent of the output voltage. The physical arrangement of the battery cells 2 in the battery support 4 remains unchanged. Only the connection scheme of the battery cells 2 is embodied differently.

The specification incorporates by reference the entire disclosure of European priority document 20 195 812.1 having a filing date of Sep. 11, 2020.

While specific embodiments of the invention have been shown and described in detail to illustrate the inventive principles, it will be understood that the invention may be embodied otherwise without departing from such principles.

What is claimed is:

1. A battery module comprising:
a total of precisely 144 battery cells connected to each other, wherein the battery cells each have an individual voltage value and wherein the battery module comprises an output voltage value;
wherein the battery module is configured to connect the battery cells to each other to form one or more groups of battery cells, wherein, when more than one group of battery cells are formed, the groups of battery cells each contain the same number of battery cells, and wherein the battery cells in each one of the one or more groups of battery cells are connected in parallel to each other;
wherein, when more than one group of battery cells are formed, the groups of battery cells are connected in series;
wherein the battery module is configured to provide different connection schemes of the battery cells to form the one or more groups of battery cells connected in series.

2. The battery module according to claim 1, wherein the battery module is configured to provide different output voltage values as a function of the different connection schemes.

3. The battery module according to claim 1, wherein the battery module is configured to provide a total of 15 different serial connections of the groups of battery cells.

4. The battery module according to claim 1, wherein all of the battery cells connected to each other are of the same configuration.

5. The battery module according to claim 1, wherein the individual voltage values of all of the battery cells connected to each other each deviate by less than 10% from an average voltage value of all of the battery cells.

6. The battery module according to claim 1, wherein the individual voltage values of all of the battery cells connected to each other each deviate by less than 5% from the average voltage value of all battery cells.

7. The battery module according to claim 1, wherein the connection schemes of the battery cells are such that the output voltage value of the battery module amounts to 1 times the average voltage value of all of the battery cells to 144 times the average voltage value of all of the battery cells.

8. The battery module according to claim 1, wherein the output voltage value of the battery module corresponds to the product of the average voltage value of all of the battery cells multiplied by 1, 2, 3, 4, 6, 8, 9, 12, 16, 18, 24, 36, 48, 72 or 144.

9. The battery module according to claim 1, wherein the one or more groups of battery cells each comprise precisely a battery number of battery cells and wherein the battery number of battery cells amounts to 1, 2, 3, 4, 6, 8, 9, 12, 16, 18, 24, 36, 48, 72 or 144.

10. The battery module according to claim 9, wherein a group number of the one or more groups of battery cells amounts to 1, 2, 3, 4, 6, 8, 9, 12, 16, 18, 24, 36, 48, 72 or 144.

11. The battery module according to claim 10, wherein a product of the battery number multiplied by the group number amounts to 144.

12. The battery module according to claim 1, wherein the battery module is configured to generate precisely 15 different output voltages through the different connection schemes.

13. The battery module according to claim 1, wherein the battery module comprises a battery cell support and wherein the battery cells are arranged spatially unchanged in the battery cell support, independent of the different connection schemes.

14. The battery module according to claim 1, wherein the battery module comprises contact paths and wherein the different connection schemes of the battery cells are realized by the contact paths.

15. A method for producing a battery module, the method comprising:
providing a total of precisely 144 battery cells each comprising an individual voltage value;
electrically connecting the battery cells to each other to form one or more groups of battery cells, and connecting the battery cells in each one of the one or more groups of battery cells in parallel to each other, wherein, when more than one group of battery cells are formed, the groups of battery cells each contain the same number of battery cells;
connecting the groups of battery cells in series to each other when more than one group of battery cells are formed.

15. The method according to claim 14, further comprising generating different output voltage values of the battery module by providing different connection schemes of the battery cells with each other for a spatially unchanged arrangement of the battery cells.
